(19) United States
(12) Patent Application Publication
(10) Pub. No.: US 2010/0255723 A1
(43) Pub. Date: Oct. 7, 2010

(54) Electric Plug Having Sealed-Off Metal Insert Parts

(76) Inventors: Hans-Peter Didra, Kusterdingen-Jettenburg (DE); Stefan Warth, Ditzingen (DE); Heinz Eisenschmid, Ditzingen-Hirschlanden (DE); Ralf Kaiser, Althuette (DE); Thomas Moelkner, Stuttgart (DE); Thorsten-Kai Janitza, Stuttgart (DE)

Correspondence Address: KENYON & KENYON LLP, ONE BROADWAY, NEW YORK, NY, 10004, US

(21) Appl. No.: 12/223,901

(22) PCT Filed: Jan. 12, 2007
(86) PCT No.: PCT/EP2007/050286

§ 371 Date: Apr. 23, 2010

(30) Foreign Application Priority Data
Feb. 21, 2006 (DE) 102006007989.2

(51) Int. Cl. H01R 13/52; H01R 43/20

(52) U.S. Cl. 439/589; 29/876

(57) ABSTRACT

In an electric plug having a plug housing made of plastic, and having at least one plastic injection molded metal insert part provided in the housing, the metal insert part is exposed at at least one housing side, and the plug housing and the metal insert parts are sealed off from each other by a cured sealing compound or adhesive compound, which is provided at the at least one housing side all the way around the exposed metal insert part.

### BACKGROUND OF THE INVENTION

1. Field of the Invention

The present invention relates to a plug for an electric plug connection.

2. Description of Related Art

Injection molding of metal insert parts using plastics for manufacturing electric plugs is widespread. The problem, in this context, is the seal tightness of the plugs at the boundary surface metal to plastic, since the continuous material connection between plastic and metal is very poor, based on the quite different coefficients of thermal expansion of that pair of substances. In order nevertheless to achieve the seal tightness of the plug, costly measures such as premolding or additional sealing elements are required.

### BRIEF SUMMARY OF THE INVENTION

By contrast, the plug according to the present invention, has the advantage that the critical connection between the metal insert parts and the injection-molded plastic is sealed off reliably and effectively using simple means. Following the standard process “Injection-Molding of Metal Insertion Parts Using Plastic”, the seal tightness at the plastic/metal boundary surface is achieved by the sealing compound or adhesive compound. The sealing compound or adhesive compound is preferably a hardened gel, especially a perfluoropolyether gel (e.g. Shin-Etsu SIFEL® 8070, Components A and B of the firm Shin-Etsu Chemical Co., Ltd., Tokyo, Japan) or a silicone gel (e.g. SEMICOSIL® 9242 of the firm Wacker-Chemie, Burghausen), or an adhesive, especially a silicone adhesive (e.g. DOW CORNING® 866 Adhesive of the firm Dow Corning GmbH, Wiesbaden). Making a seal using a gel seal is a proven standard method, which is distinguished by low costs and simple handling. It ensures a good connection both at the plastic and at the metal of the insert part, this connection being still fulfilled even under high vibration stresses.

The plug according to the present invention may be used, for instance, as an electrical feed-through lead in the oil region of a vehicle engine, especially as an electrical feed-through lead out of the oil-free inner space of an high pressure sensor that has an electronics system sensitive to environmental influences, so as to seal off the oil region. The plug is preferably a part of a pressure sensor recording the rail pressure, whose electric lines are guided to the outside through the plug according to the present invention.

### BRIEF DESCRIPTION OF THE SEVERAL VIEWS OF THE DRAWING

FIG. 1 shows the plug according to the present invention having a sealed-off fastening flange.

FIG. 2 shows the plug according to the present invention having sealed-off electric contacts.

FIG. 3 shows a pressure sensor having the plug according to the present invention, in which the electric contacts and the fastening flange are sealed off.

### DETAILED DESCRIPTION OF THE INVENTION

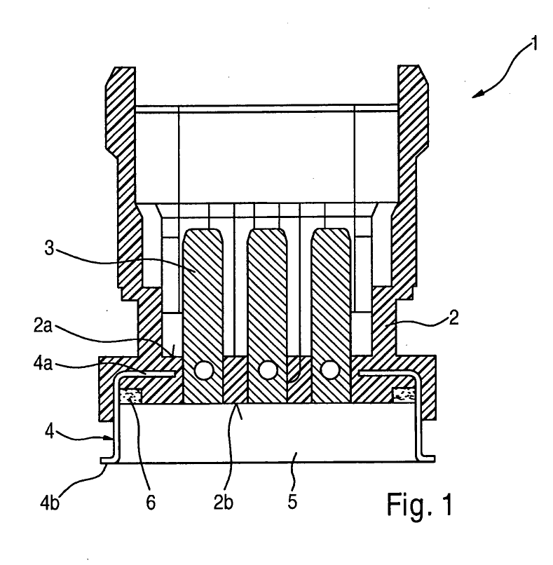

Plug 1 shown in FIG. 1 of an electric plug connection includes a plug housing 2 made of plastic and in it metal insert parts injection-molded in plastic, namely three electric contacts (pins) 3 and an encircling fastening flange 4. Ring-shaped or sleeve-shaped fastening flange 4 is a deep-drawn part, whose plastic injection-molded end 4a is bent inwards, and whose flange end 4b, that protrudes outwards, defines an inner space 5. Electric contacts 3 enter into plug housing 2 at housing side 2a that faces away from inner space 5, and exit from plug housing 2 into inner space 5 at housing side 2b that faces inner space 5.

Plug 1 is produced in an injection molding process of plastic and having contacts 3 and fastening flange 4 as metal insert parts and is subsequently cooled. However, the connection between plug housing 2 and metal insert parts 3, 4 is not tight because of the quite different coefficients of thermal expansion of plastic and metal, so that, for example, water is able to get into inner space 5 from the outside, along a gap between plug housing 2 and electric contacts 3 and fastening flange 4.

In order to achieve the tightness of plug 1 anyway, plug housing 2 and plastic injection molded fastening flange 4 in FIG. 1 are sealed off from each other by a cured sealing compound or adhesive compound 6, which is applied on the inner space side on housing side 2b facing inner space 5 all the way around fastening flange 4, that is, at the exposed inside plastic/metal boundary surface. Although it is not shown, sealing compound or adhesive compound 6 may of course also be applied outside of inner space 5 at the exposed outside plastic/metal boundary surface, all the way around fastening flange 4.

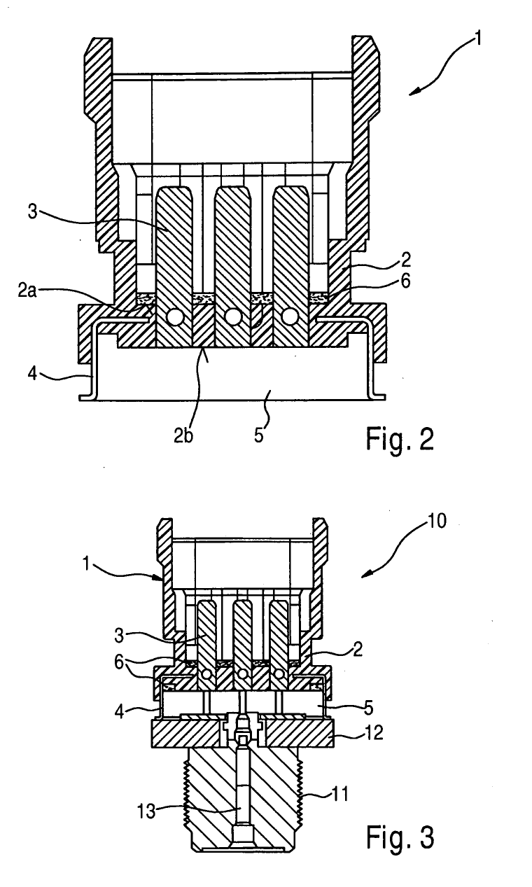

In a manner different from that in FIG. 1, in plug 1 shown in FIG. 2, plug housing 2 and plastic injection molded electric contacts 3 are sealed off from each other by cured sealing compound or adhesive compound 6, which is applied on housing side 2a facing away from inner space 5 in each case all the way around contacts 3. Although this is not shown, it is of course also possible to have sealing of contacts 3 on the inner space side, as well as a duplicate sealing of contacts 3, that is, at both housing sides 2a, 2b.

Cured sealing compound or adhesive compound 6 is produced impermeable to liquid, and by using a gel seal or an adhesive seal, in that a formable and curable sealing compound or adhesive compound is applied to respective housing side 2a or 2b all the way around contacts 3 and all the way around fastening flange 4 and is cured. In the preparation, processing and curing, using suitable measures, one is able to achieve that cured sealing compound or adhesive compound 6 is free from bubbles. Instead of covering housing side 2a, 2b only from point to point, as shown, with sealing compound or adhesive compound 6 in the area of metal insert parts 3, 4, housing side 2a, 2b may of course also be covered over a large surface or the whole surface using sealing compound or adhesive compound 6, preferably using an uniform layer thickness.

FIG. 3 shows a rail pressure sensor 10 having a plug 1 developed as above. Using a threaded socket 11, rail pressure sensor 10 closes an opening in the fuel pressure accumulator (common rail), a hex nut 12 being used to screw it in. Plug 1 is tightly fastened to hex nut 12 with its fastening flange 4, for instance, welded on. A pressure sensor (not shown) is mounted in inner space 5, which is connected to the fuel pressure accumulator via a measuring line 13 of threaded socket 11. Plug 1 is thus used as a liquid-tight feed-through lead of the electrical lines of the pressure sensor from inner space 5 of rail pressure sensor 10 that is protected from environmental influences. In the case of plug 1 shown in FIG. 3, both electric contacts 3, as shown in FIG. 2, and fastening flange 4, as shown in FIG. 1, are sealed off by sealing compound or adhesive compound 6.

1-9. (canceled)

10. An electric plug, comprising:
a plug housing made of plastic; and
at least one metal insert part molded into a plastic portion by injection-molding, wherein the at least one metal insert part is exposed at at least one side of the plug housing, and wherein the plug housing and the at least one metal insert part are sealed off from each other by one of a cured sealing compound or an adhesive compound provided at the at least one side of the housing completely around the exposed metal insert part.

11. The plug as recited in claim 10, wherein the at least one metal insert part is exposed at two sides of the plug housing.

12. The plug as recited in claim 11, wherein the at least one metal insert part is at least one of an electric contact and a fastening flange of the electric plug.

13. The plug as recited in claim 12, wherein the one of the cured sealing compound or the adhesive compound is impervious to liquid and gas.

14. The plug as recited in claim 12, wherein the one of the cured sealing compound or the adhesive compound is a curable gel in the form of one of a perfluoropolyether gel or a silicone gel.

15. The plug as recited in claim 12, wherein the one of the cured sealing compound or the adhesive compound is a curable adhesive in the form of a silicone adhesive.

16. The plug as recited in claim 12, wherein the entire surface of the at least one housing side is covered by the one of the cured sealing compound or the adhesive compound.

17. The plug as recited in claim 12, wherein the plug is incorporated as a component of a rail pressure sensor.

18. A method for sealing an electric plug having a plug housing made of plastic and at least one metal insert part molded into a plastic portion by injection-molding, the at least one metal insert part being exposed at at least one side of the plug housing, comprising:
applying one of a curable sealing compound or an adhesive compound at the at least one side of the housing completely around the exposed metal insert part; and
curing the one of the curable sealing compound or the adhesive compound.
